(19) United States
(12) Patent Application Publication
(10) Pub. No.: US 2011/0002478 A1
(43) Pub. Date: Jan. 6, 2011

(54) HEADSET

(75) Inventors: Kieran Pollard, Hong Kong (CN); Jonathan David Lowy, Auckland (NZ)

Correspondence Address: COOPER & DUNHAM, LLP, 30 Rockefeller Plaza, 20th Floor, NEW YORK, NY, 10112, US

(73) Assignee: OBJECTIVE CONCEPTS LIMITED, Auckland (NZ)

(21) Appl. No.: 12/734,561

(22) PCT Filed: Nov. 7, 2008
(86) PCT No.: PCT/NZ2008/000301

§ 371 Date: Sep. 13, 2010

(30) Foreign Application Priority Data
Nov. 7, 2007 (NZ) 563243

(51) Int. Cl. H04R 1/10; H04R 25/00

(52) U.S. Cl. 381/74; 381/373

(57) ABSTRACT

A headset includes an ear-cup having speaker means operable to output sound in first and second modes, the speaker means being appropriate for use as headphones in the first mode and for use as a loudspeaker in the second mode, a volume in the second mode being generally greater than that of the first mode when in use, and at least one vent for selectively allowing air to pass from inside the ear-cup to outside the ear-cup, in use.

### FIELD OF INVENTION

This invention relates generally to a headset. More particularly, embodiments of the invention provide a headset which can be operated in a headphone or a speaker mode.

### BACKGROUND TO THE INVENTION

With the use of audio devices such as CD or MP3 players, users generally have a choice of two different ways in which to listen to the output of such devices. The first uses headphones, which enables the user to listen to the audio output in private without disturbing other people. The second uses speakers which enable the audio output to be shared and avoids user discomfort by not requiring the user to wear equipment on their head. Users may wish to switch from one form of output to the other depending on their circumstances. Also, users may simply become tired of wearing headphones or from having the sound so close to their ears. In such situations, users can switch to a speaker arrangement. This conventionally required the user to have two separate pieces of equipment (i.e., headphones and speakers), which can be of great inconvenience.

One solution to this problem is described in US 2006/0159279 A1, namely, a multimedia speaker headphone which acts in both a headphone mode and a speaker mode. The multimedia speaker headphone utilises four speakers, two earphone speakers and two audio speakers. The earphone speakers are mounted on the internal sides of two ear-cups adjacent to a user's ears and the audio speakers are attached on the opposite sides of the ear-cups. To switch between the earphone speakers and the audio speakers there is a switch in line with the input cable which has to be switched manually. A problem with this arrangement is that the complexity and cost of the device is increased, as four speakers need to be used. Furthermore, the switch needs to be manually switched and can be accidentally switched between the two different modes. When wearing a headset in a headphone mode, accidental switching to speaker mode may disturb others in the vicinity. Moreover, it may cause temporary or even permanent hearing damage to the user by having the louder audio speakers outputting sound in such close proximity to their ears.

### SUMMARY OF THE INVENTION

It is an object of the invention to provide a headset which can operate in a headphone or speaker mode which mitigates at least some of the aforementioned problems.

Alternatively, it is an object of the invention to provide at least a useful choice to the public.

According to a first aspect of the invention there is provided a headset including:
an ear-cup having speaker means operable to output sound in first and second modes, the speaker means being appropriate for use as headphones in the first mode and for use as a loudspeaker in the second mode, the volume in the second mode being generally greater than that of the first mode when in use,
wherein the headset is configurable in a first configuration to be worn by a user such that the speaker means is proximate an ear of the user and in a second configuration for use as a loudspeaker, and
wherein control means are provided to ensure that the speaker means is in the first mode when the headset is in the first configuration.

Preferably, the headset includes a pair of ear-cups, each having speaker means operable in the first and second modes dependent on the configuration of the headset.

While according to preferred embodiments each ear-cup has a single speaker adapted to operate in the first and second modes, the scope of the invention is not limited thereto and includes ear-cups having separate speakers for the first and second modes as well as ear-cups having a plurality of speakers, wherein a plural number of speakers in an ear-cup are configured to operate when in the first and/or second mode.

Where common speaker(s) are used for the first and second modes, preferably, the headset includes an audio amplifier configured to amplify an audio input to two different levels depending on the mode of operation.

Preferably, the control means includes means for detecting when the headset is in the first configuration and/or in the second configuration.

Thus, the control means in combination with the means for detecting may detect when the headset is in each configuration or alternatively, detect when the headset is in one of the two configurations and assume that the headset is in the other configuration, by default, when the headset is not in the one configuration. To improve safety, preferably the speaker means is configured to operate in the first mode unless there is a positive detection that the headset is in the second configuration.

Preferably, the means for detecting is configured to detect when the two ear-cups are proximate to and/or abut and/or are connected to one another.

Preferably, the means for detecting includes any one or more of a magnetic sensor, a reed switch, a Hall effect sensor, a mechanical switch, or an optical switch.

Preferably, the two ear-cups abut and/or are connected to one another in the second configuration such that it is at least not possible for each ear-cup of a pair of ear-cups to be positioned over respective ears, of a user.

Preferably, the control means includes or is operably connected to a switch for switching the output of the speaker means between the first and second modes.

Preferably, the control means is configured to actuate the switch based at least in part on the output of the means for detecting.

Preferably, the switch is integral to the means for detecting.

Thus, the invention provides for automatic switching between a headphone mode and a loudspeaker mode depending on the configuration or orientation of the ear-cups, whereby the level of amplification is higher for loudspeaker mode than it is for headphone mode. This is an important safety feature as likelihood of damage being caused to a user's hearing will be much reduced by avoiding accidental changes from headphone mode to loudspeaker mode while the user is wearing the headset.

While switching between the modes is preferably performed automatically depending on the configuration of the headset, a manual switch may be additionally provided as a safety switch such that, in addition to the automatic switching, a user must make a conscious action to switch between modes.

Preferably, the or each ear-cup includes at least one vent, the at least one vent being configured to be open when the headset is in the first configuration and the at least one vent being configured to be closed when the headset is in the second configuration.

Preferably, the control means is configured to open the at least one vent when the headset is in the first configuration.

Preferably, the headset includes manual actuator means for opening and closing the at least one vent.

Preferably, the or each ear-cup includes an earpad having at least one vent.

Preferably, the headset includes noise cancellation means which is activated when the headset is in the first configuration.

### BRIEF DESCRIPTION OF THE DRAWINGS

Embodiments of the invention will now be described, by way of example only, with reference to the accompanying drawings in which:

FIG. 1 is a side view of an embodiment of the apparatus of the invention in a first configuration;

FIG. 2 is a side view of an embodiment of the apparatus of the invention in a second configuration;

FIG. 3 is a perspective view of an alternative embodiment of the invention; and

FIG. 4 is a schematic block diagram showing the functioning of an embodiment of the invention.

### DETAILED DESCRIPTION OF PREFERRED EMBODIMENTS

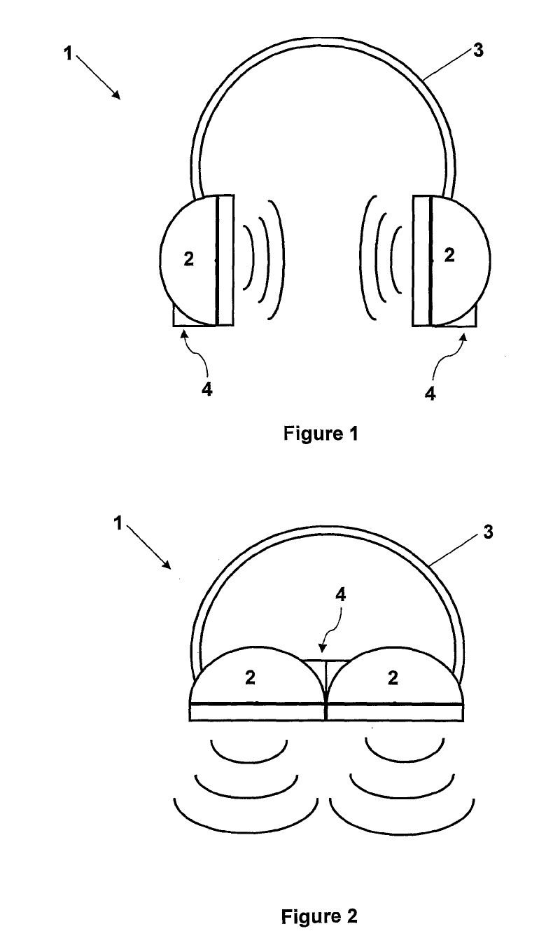

FIG. 1 is a side view of a headset generally marked 1 according to an embodiment of the invention in a first, headphone mode. FIG. 2 is a side view of the headset of FIG. 1 in a second, loudspeaker mode. Headset 1 comprises two ear-cups 2 connected together via headband 3. At least one speaker (not shown) is preferably provided in each ear-cup although the invention also covers headsets having a single ear-cup for outputting sound, wherein the other ear-cup may be of generally the same configuration (but with the omission of a speaker) or may simply comprise a support at one end of headband 3 which rests against the head, generally slightly above one ear, as would be apparent to one skilled in the art. For example, embodiments of the headset of the invention may be embodied by a telephone headset (having one or two speakers and a microphone associated therewith). Thus, embodiments of the invention may provide a headset for a telephone, including Internet telephones (e.g. skype phones), capable of operating in a loudspeaker mode. The headset receives signals via wired and/or wireless communication means, including via BlueTooth or WLAN protocols, although the invention is not limited thereto.

According to the embodiment shown in FIGS. 1 and 2, ear-cups 2 are rotatably coupled to headband 3 so as to enable them to move from the configuration shown in FIG. 1 to that shown in FIG. 2. In the configuration of FIG. 1, headset 1 is adapted to be worn by a user in a conventional manner with an ear-cup 2 covering each ear. In the configuration of FIG. 2, headset 1 is adapted for use as a loudspeaker unit.

The invention is not limited to the configuration shown in FIG. 2. The essential feature of the configuration of FIG. 2 is that headset 1 cannot be worn in a conventional manner with an ear-cup covering each ear. Also, while a particular ear-cup/headband configuration has been shown, the invention is not limited thereto. It will be apparent to those skilled in the art that various other configurations and means may be used which enable a headset to be configured in two different ways, one in which the headset may be worn conventionally and the other in which it is not possible for the headset to be worn conventionally covering both ears. All such configurations and means are included within the scope of the invention.

Preferably, the apparatus of the invention includes or is couplable to a power supply for driving elements thereof.

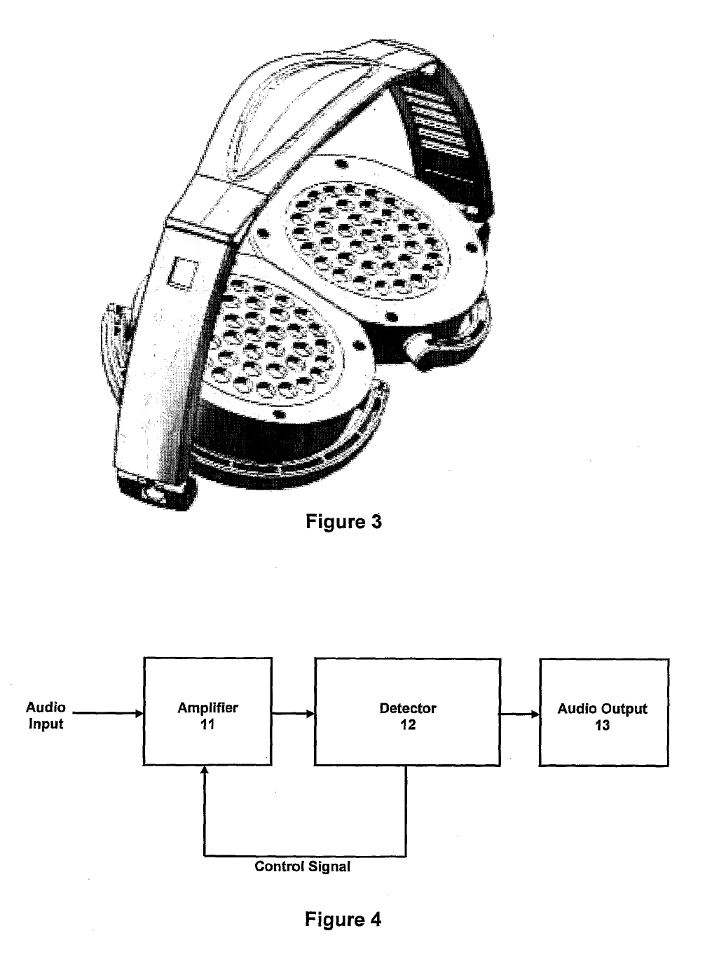

FIG. 3 is a perspective view of headset 5 according to an alternative embodiment of the invention, arranged in the second, loudspeaker configuration. Headset 5 of FIG. 3 has the same general construction and functionality of that of FIGS. 1 and 2 and only points of distinction will be described. Like references have been used to denote like elements.

According to the embodiment of FIG. 3, when in the second configuration, headband 3 extends vertically upwards from ear-cups 2 such that headset 5 takes up less space on the surface on which it rests. This also enables headband 3 to conveniently act as a handle for the loudspeaker unit. Preferably, in this configuration, ear-cups 2 are oriented with the drivers or speakers facing upwards. However, other orientations of the ear-cups (and drivers/speakers) are included within the scope of the invention. For example, the drivers may be arranged to be substantially horizontal or any angle between vertical and horizontal. The outer surface of ear-cups 2 may be adapted, as required, so as to provide support for and hold ear-cups 2 in a particular desired orientation.

FIG. 4 is a schematic block diagram showing functional components of an embodiment of the invention. Preferably, the components shown in FIG. 4 are included within a headset, more preferably, within the ear-cups thereof, with communicative/electrical coupling therebetween provided in a conventional manner, such as by means of wiring in or attached to the headband. However, one or more elements of the apparatus may be provided remote from the headset. Thus, according to one particular embodiment, a power supply and/or an amplifier are provided remote from the headset but electrically coupled thereto. The one or more remote elements may be detachable from the headset. The one or more remote elements may, for example, be provided in a mounting coupled to a cable conventionally connected to headsets, similar to a medallion; attached proximate the audio input source (e.g. a music player); or configured for attachment to a user, such as to a belt worn thereby. Other alternatives will be apparent to one of skill in the art and are included within the scope of the invention.

According to particular embodiments, the audio signal source may provide electrical power for elements of the invention. According to such embodiments, the same connector or group of connectors may be used for supplying power and the audio signal. For example, USB interfaces/cabling may be used. Other arrangements will also be apparent to those skilled in the art. For example, Apple iPods may be provided with a 30 pin conncector for providing electricity.

An audio input signal provided to audio amplifier 11 is output via output means 13 (preferably a speaker). Detector 12 detects whether the headset is to operate as a headset (i.e., headphones) or a loudspeaker unit, and based thereon, sends a control signal to amplifier 11. The level of amplification by amplifier 11 is based at least in part on this control signal. Namely, a lower level of amplification is provided when the headset is to operate as headphones than when it is to operate as a loudspeaker unit.

According to preferred embodiments, detector 12 is configured to detect a mode of operation of the headset based, at least in part, on the configuration of the headset. More particularly, detector 12 is preferably includes switch means 4 (see FIGS. 1 and 2) which are activated/deactivated depending on the headset configuration. Thus, movement of the ear-cups from the configuration shown in FIG. 1 to that shown in FIG. 2 causes a change in the state of switch means 4. Switch means 4 may be a mechanical switch which is activated/deactivated when the two ear-cups abut one another. However, presently preferred embodiments use magnetic sensors, reed switching, Hall Effect switching or optical switching to sense the proximity of the ear-cups (or proximity of relevant portions of the ear-cups) to each other. Other detection and/or switching means will be apparent to those skilled in art and all such alternatives are included within the scope of the invention.

When it is detected by switch means 4 that headset 1 is in the configuration of FIG. 1 (conversely, when it is not detected that headset 1 is in the configuration of FIG. 2), the control signal from detector 12 preferably sets no or a reduced level of gain for amplifier 11. However, when a user changes the configuration of headset 1 to the configuration of FIG. 2, switching means 4 undergoes a change in state (i.e., it is activated/deactivated) resulting in a change in the control signal which causes amplifier 11 to provide a higher level of amplification such that the headset operates as a loudspeaker unit.

References to “lower” or “reduced” levels of gain are used as a comparison with the “higher” level of gain generally required when the headset operates as a loudspeaker unit.

According to preferred embodiments, switch means 4 and/or detector 12 (which may be an integral unit) set the amplification of amplifier 11 to no or a lower level of gain unless there is a positive detection that the headset is in the second, speaker unit configuration. Such embodiments further reduce the likelihood of the headset accidentally switching to loudspeaker mode when the headset is worn in a conventional manner with an ear-cup covering each ear of a user, thereby reducing the likelihood of damage to the hearing of the user.

The same or different speakers may be used for each mode of operation and the commonality between other components of the circuitry may be varied as desired For example, separate amplifiers may be provided for each mode.

According to preferred embodiments, the same speakers are used for both modes so as to reduce the number of components in and weight of each earcup. In such embodiments the speaker response is attenuated electrically and mechanically for the appropriate audio output according to whether the headset is in loudspeaker or conventional headphone mode.

Where separate speakers or drivers are used for each mode of operation; the speakers in loudspeaker mode are different to those in conventional headphone mode, although they are located in the same ear-cup. In this arrangement the audio performance of both modes is enhanced compared to the embodiment in which the same speakers are used since the speakers are better suited to their requisite purpose, without the need for compromise. According to such embodiments, control means route the audio signals to the required speakers.

In a still further embodiment, multiple speakers or drivers are provided for use when the headset is in loudspeaker mode. This embodiment advantageously allows for stereo sound effects, for example surround sound, or may provide increased overall power output, hence higher volumes, compared to what can be achieved with a single speaker.

Embodiments of the invention may include vents.

A first type of vent comprises holes, pipes or channels In each ear-cup allowing air to pass from the volume inside the ear-cup (more particularly, the enclosed volume of the ear-cup which substantially corresponds to the volume of the ear-cup behind the speaker mounted therein) to outside the ear-cup. Vented ear-cups allow air to move in and out of the cup to provide a more ‘natural’ sound which is favoured by some users. In a preferred embodiment, the vents are configured to be in a closed state when the headset is in loudspeaker mode and in an open state when the headset is in conventional headphone mode. When the vents are closed the driver diaphragm behaves as if stiffened, increasing the bass response at the expense of the mid and high ranges; a desired situation when in loudspeaker mode. When the vents are open the response is biased towards the mid and high ranges to improve audio quality as required in conventional headphone mode. The vents are adapted to change from the open state to the closed state and vice versa automatically in response to the change of configuration or mode of the headset in a preferred embodiment. Vent opening and closing means receives a control signal from the detector when the switching means undergoes a change in state caused by a change in configuration of the headset. The control signal causes the vents to open and/or close.

In alternative embodiments, the vents may be open and closed by manual actuator means as well as, or instead of, automatically.

A second type of vent allows air to move from the volume directly around a user's ear that is bounded by the earpad and the front face of the ear-cup (substantially the side of the speaker closest to a user's head when conventionally worn) to outside the ear-cup. To this end, a vent pipe of at least one hole may be provided in an earpad. In one example the earpad is backed with an open weave mesh to allow some air to flow in and out of the earpad. In the case of leatherette PVC or other plastic earpads, for example, holes may be punched in the earpad. Such a leakage path between the ear-space and the free air volume outside the earpad reduces the mechanical constraint of the speaker surface and improves audio quality.

The first and second type of vents may be used separately or in combination.

Embodiments of the invention may include components and/or software for bass enhancement and surround sound functionality, more particularly, artificial bass enhancement and artificial surround sound functionality.

Embodiments of the invention may include components and/or software for providing noise cancellation functionality. As is known in the art, in these embodiments the headset includes a device which is activated when the headset is in conventional headphone mode for adding to the output audio signal a signal which is approximately inverse to a sample of background noise in order to cancel out the levels of background noise present in the audio output signal.

Other embodiments of the invention include various headphone features or additional functionality as will be known to those skilled in the art.

While preferred embodiments of the invention have been described as having wired connections between various elements thereof, the invention is not limited thereto. Any known means, including wireless interfaces, may be used to transfer signals between the elements with additional power supplies added as required. For example, BlueTooth or WLAN protocols (i.e., 802.11) may be used.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the scope of the invention.

1-22. (canceled)

23. A headset comprising:
an ear-cup having speaker means operable to output sound in first and second modes, the speaker means being appropriate for use as headphones in the first mode and for use as a loudspeaker in the second mode, a volume in the second mode being generally greater than that of the first mode when in use, and
at least one vent for selectively allowing air to pass from inside the ear-cup to outside the ear-cup, in use.

24. A headset as claimed in claim 23, wherein the at least one vent is configurable to be open when the headset is in the first mode and/or to be closed when the headset is in the second mode.

25. A headset as claimed in claim 23, further comprising switching means for automatically opening and/or closing the vent based on the mode of operation.

26. A headset as claimed in claim 23, further comprising a manual actuator for opening and/or closing the at least one vent.

27. A headset as claimed in claim 23, further comprising a pair of said ear-cups.

28. A headset as claimed in claim 23, wherein the speaker means comprises a single speaker adapted to operate in both the first and second modes.

29. A headset as claimed in claim 28, wherein the headset includes an audio amplifier configured to amplify an audio input to two different levels depending on the mode of operation.

30. A headset as claimed in claim 23, wherein the speaker means comprises separate speakers for the first and second modes.

31. A headset as claimed in claim 23, wherein the ear-cup comprises a plurality of speakers, wherein a plural number of speakers in an ear-cup are configured to operate when in the first and/or second mode.

32. A headset as claimed in claim 23, wherein the headset is configurable in a first configuration to be worn by a user such that the speaker means is proximate an ear or a respective ear of the user and in a second configuration for use as a loudspeaker, and
wherein control means are provided to ensure that the speaker means is in the first mode when the headset is in the first configuration.

33. A headset as claimed in claim 32, wherein the at least one vent is configured to be open when the headset is in the first configuration and the at least one vent is configured to be closed when the headset is in the second configuration.

34. A headset as claimed in claim 32, wherein the control means comprises means for detecting when the headset is in the first configuration and/or in the second configuration.

35. A headset as claimed in claim 32, wherein the speaker means is configured to operate in the first mode unless there is a positive detection that the headset is in the second configuration.

36. A headset as claimed in claim 34, wherein the means for detecting is configured to detect when the two ear-cups are proximate to and/or abut and/or are connected to one another.

37. A headset as claimed in claim 27, wherein the headset is configurable in a first configuration to be worn by a user such that the speaker means is proximate an ear or a respective ear of the user and in a second configuration for use as a loudspeaker, and
wherein the pair of ear-cups abut and/or are connected to one another in the second configuration such that it is at least not possible for each ear-cup of the pair of ear-cups to be positioned over respective ears of a user in the second mode.

38. A headset as claimed in claim 23, further comprising control means operably connected to a switch for switching an output of the speaker means between the first and second modes.

39. A headset as claimed in claim 34, wherein the control means is operably connected to a switch for switching an output of the speaker means between the first and second modes, wherein the control means is configured to actuate the switch based at least in part on the output of the means for detecting.

40. A headset as claimed in claim 39, wherein the switch is integral to the means for detecting.

41. A headset as claimed in claim 23, further comprising a manual switch for switching an output of the speaker means between the first and second modes.

42. A headset as claimed in claim 23, wherein the ear-cup comprises an earpad having at least one vent or aperture.

43. A headset as claimed in claim 42, wherein a surface of the earpad configured to face the respective ear-cup is covered with an open weave mesh to allow air to flow in and out of the earpad.

44. A headset as claimed in claim 23, wherein a headband of the headset is configured to extend substantially vertically upwards when in the second mode.

45. A headset as claimed in claim 23, configured to orient the speaker means substantially upwards in the second mode.

46. A headset as claimed in claim 23, wherein the headset further comprises noise cancellation means which is activated when the headset is in the first mode.

47. A headset comprising:
at least one ear-cup having at least one speaker operable to output sound in first and second modes, the at least one speaker being appropriate for use as headphones in the first mode and for use as a loudspeaker in the second mode, a volume in the second mode being generally greater than that of the first mode when in use, and
at least one vent for selectively allowing air to pass from inside the at least one ear-cup to outside the at least one ear-cup, in use.
